(19) United States
(12) Patent Application Publication
(10) Pub. No.: US 2020/0111010 A1
(43) Pub. Date: Apr. 9, 2020

(54) METHOD AND APPARATUS FOR VEHICLE-TUNED ROAD EVALUATION AND RECOMMENDATION

(71) Applicant: FORD GLOBAL TECHNOLOGIES, LLC, Dearborn, MI (US)

(72) Inventor: Abraham MEZAAEL, Southfield, MI (US)

(21) Appl. No.: 16/152,048

(22) Filed: Oct. 4, 2018

(51) Int. Cl. G06N 5/04; G01C 21/34; H04W 4/40; H04W 4/02

(52) U.S. Cl. CPC G06N 5/04; H04W 4/023; H04W 4/40; G01C 21/3461

(57) ABSTRACT

A system includes a processor configured to receive data indicating a detected vehicle-event, event location, and vehicle traits. The processor is also configured to add the data to a combined set of events occurring within a predefined proximity of the location. The processor is further configured to determine, from the set, a common vehicle trait, responsive to occurrence of the events in the set exceeding a threshold, for the location and designate the location as likely to cause the event for vehicles having the trait.

### TECHNICAL FIELD

The illustrative embodiments generally relate to methods and apparatuses for vehicle-tuned road evaluation and recommendation.

### BACKGROUND

Whenever new roads are developed or planned, there is often an attempt accommodate future traffic and planned needs. But, because roads tend to last for decades, this planning is often inadequate for future travel needs. At the same time, building around natural and man-made features can cause construction of sub-optimal roads, which, again, can last for decades. Also, demolition or reconstruction of roads can lead to diverted or new traffic flows, which were never considered by the newly-used road's original planners. New developments, new growth and new expansion are constantly ongoing, and yet road networks, because of the massive resources required to lay them, remain largely tied to original plans.

Sometimes, road problems may not become apparent until a demographic or technological shift has occurred. For example, before the advent of the sport utility vehicle (SUV), many vehicles had low centers of gravity and could more easily accommodate un-banked, sharp turns. Vehicle bodies may have been shorter or narrower as well, and thus road-width through tight spaces was intended to accommodate such vehicles. As SUVs became more prevalent, banked turns, wider avenues and wider turns became important. In other cases, areas built to handle largely consumer traffic may suddenly require accommodation for commercial trucking and construction trucking, if those areas experience sudden growth. Low overpasses, sharp turns and winding roads may be unsuitable for much of such traffic.

Given the massive size of road networks, there is a need to prioritize improvement planning, as all roads cannot be fixed and replaced at all times. When a road cannot be changed (such as a road running down a narrow path between two immovable, or preferably immovable, objects), drivers of certain vehicles may simply want to avoid that road altogether. Unfortunately, little to no modern navigation equipment is also self-aware of vehicle size constraints, making it incapable of recommending avoidance of unsuitable (for a given vehicle) passage.

### SUMMARY

In a first illustrative embodiment, a system includes a processor configured to receive data indicating a detected vehicle-event, event location, and vehicle traits. The processor is also configured to add the data to a combined set of events occurring within a predefined proximity of the location. The processor is further configured to determine, from the set, a common vehicle trait, responsive to occurrence of the events in the set exceeding a threshold, for the location and designate the location as likely to cause the event for vehicles having the trait.

In a second illustrative embodiment, a system includes a processor configured to receive data indicating a detected vehicle-event, event location, and environmental condition. The processor is also configured to add the data to a combined set of events occurring within a predefined proximity of the location. Further, the processor is configured to determine, from the set, a common environmental condition, responsive to occurrence of the events in the set exceeding a threshold, for the location, and designate the location as likely to cause the event for vehicles when the condition is present.

In a third illustrative embodiment, a system includes a processor configured to determine that a route includes a location predesignated to cause a predefined undesirable vehicle event, based on a vehicle trait or environmental condition pre-associated with the location as an event cause. Also, the processor is configured to recommend an alternative route avoiding the location, responsive to a vehicle traveling the route having the trait, or condition likely to be present when the vehicle reaches the location, depending on a respective event cause type. That is, the processor is configured to issue the recommendation if the vehicle has the trait and the cause is a vehicle trait, making the cause type a trait, or the processor is configured to issue the recommendation if the condition (e.g., weather or traffic) is likely to be present (based on, for example, known conditions, weather/traffic patterns, etc) when the vehicle reaches the location and the cause is a condition, making the cause type a condition.

### BRIEF DESCRIPTION OF THE DRAWINGS

FIG. 1 shows an illustrative vehicle computing system;

FIGS. 2A-2C show illustrative examples of error-detection and analysis processes;

FIG. 3 shows an illustrative process for problem-targeting and monitoring;

FIG. 4 shows an illustrative monitoring-distribution process;

FIG. 5 shows an illustrative navigation-alert and re-routing process.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

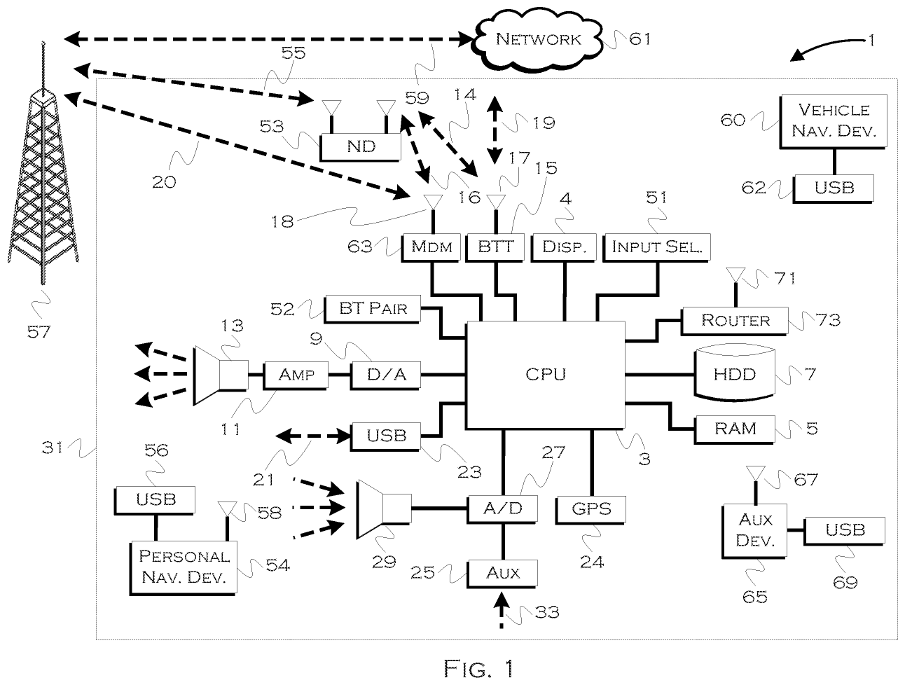

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

It is virtually impossible to determine what the future traffic on a given roadway will resemble. Vehicular-demographic modeling and predictions can only go so far, and they certainly cannot accommodate chassis that are not even contemplated at the time of planning. The illustrative embodiments provide for increased optics on what vehicles are traveling where, where beneficial network improvements can be made, and what areas are unchangeable but also unsuitable for a given vehicle type or class. For example, a dirt road may impact an SUV owner very little, but may commonly destroy the ground-effects on sports cars. If the sports-car travel over such a road was infrequent, the best option (from a planning perspective) might be to have sports-cars avoid this road. This commonly involves the drivers having personal knowledge of the road, but when a vehicle is traveling over unsuitable, unfamiliar territory, the driver may not know until it is too late.

At the same time, if there was limited SUV travel over the road, and heavy sports car travel in the area of, or over, the road, a better option might be to simply resurface the road. This would accommodate the local populace's vehicle demographics while curing the issue of the uninformed driver. Municipalities, however, have little methodology for determining the composition of traffic, and very limited access to ongoing and shifting data.

For either of the preceding scenarios, the illustrative embodiments improve the current systems by providing both ongoing optics on vehicle demographic composition and vehicle-tuned navigation to assist until if and when a change is made. That is, a municipality may be better able to see the over-time change whereby the population would benefit from a resurfacing, long before receiving sufficient complaints to indicate the same, and unfamiliar drivers would know in advance to avoid a given road or passage that is unsuitable for their particular vehicle. These are but a few ways in which the illustrative embodiments improve the current situation and create new opportunity.

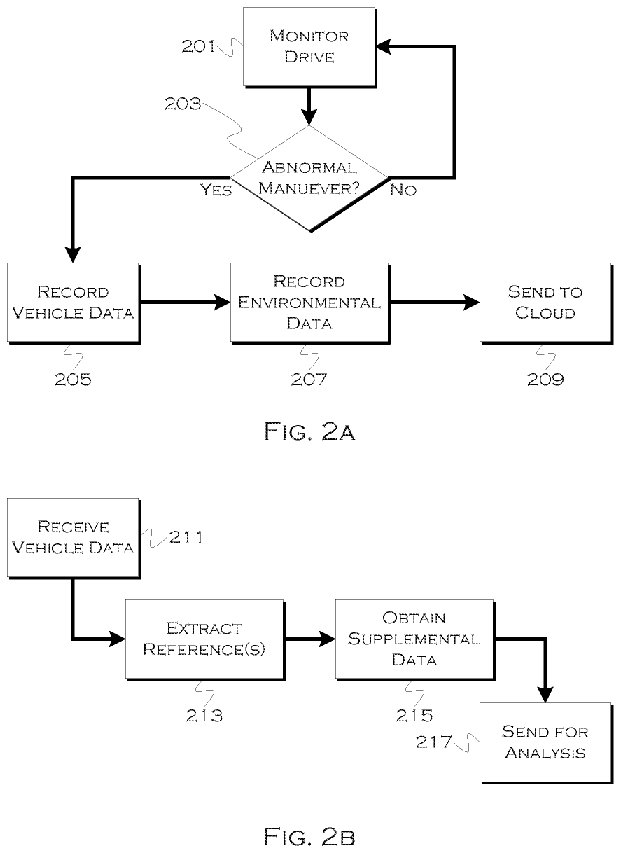

FIGS. 2A-2C show illustrative examples of error-detection and analysis processes. The illustrative embodiments leverage a wide network of traveling vehicles to detect unfavorable conditions and then determine whether the conditions are vehicle-centric, vehicle-type-centric, vehicle-characteristic-centric or road-centric, among other things. Vehicle-centric conditions may be those limited to a specific vehicle. Due to a malfunction, for example, a given vehicle may experience unsuitable conditions in a variety of circumstances that would not bother other drivers, even of a same make and model of the monitored vehicle.

Vehicle-type-centric conditions may be those experienced commonly by certain types of vehicles. This may effectively be a wider class than vehicle-characteristic-centric conditions, which can reduce the analysis to a certain trait (weight, length, width, etc.) which is actually resulting in the observed problem. So, for example, early analysis may reveal that 90 percent of trucks experience unacceptable slippage when turning right down a declined 90-degree turn. Further observation may reveal that the 90 percent of trucks all share a drivetrain or tire characteristic, and thus the problem relates to both a combination of the weight and drivetrain or tire characteristic. Turn-speed may be another characteristic factor.

Knowing all this information allows the city to decide if the grade of the turn should be changed, and the city can also know how frequently this occurs, which can further inform the decision. Meanwhile, until the grade changes, certain trucks can be told to avoid the turn, while other trucks may be told to take the turn at no faster than a certain speed.

While “telling the truck” often means telling the driver, under most modern scenarios, in an autonomous vehicle (AV) sense the vehicle itself can be given specific-performance instructions based on the vehicle's present characteristics. This can avoid future accidents and can be used to effectively “teach” the autonomous vehicles based on previously observed occurrences, without the vehicle itself having to experience the issue. FIGS. 2A-2C relate to these observations and illustrate a non-limiting set of processes for making the same.

The process in a given vehicle, shown in FIG. 2A, monitors 201 the current drive of the vehicle. With sufficient bandwidth and data freedom, this monitoring could also be done remotely, but in his example this process executes on the vehicle itself, or on a device within the vehicle, capable of determining the required information. If the process detects 203 abnormal behavior, the process can record 205, 207 current vehicle and environmental data, and send 209 the data to the cloud for group-processing.

The vehicle data can include, but is not limited, to, slippage, anti-lock brake engagement, impact, speeds, gear states, etc. The environmental data can include surface measurements, smoothness, location, weather, traffic, etc. This data, in combinatorial analysis, can, with sufficient volume, usually produce root-causes or conditions associated with an observed state. That is, if 10,000 vehicles experience anti-lock brake engagement in rain over a down-slope, a conclusion that the slope is too steep for rain across most vehicles may be drawn. If the same results are limited to 1,000 vehicles, over 4 tons, and the remaining 9,000 vehicles are under 4 tons, a correlation between road grade, vehicle weight and weather may be drawn. This may be insufficient justification to change a road, but sufficient justification to tell drivers or AVs of over 4 tons to avoid this road in rain.

The cloud-process in FIG. 2B may receive 211 the vehicle data from thousands of vehicles. It extracts 213 reference points for analysis, such as the vehicle and/or environmental characteristics. Some data, such as weather data, may not be directly gatherable from the vehicle, but a time stamp and reasonable weather pattern map may provide the same insight. Thus, the process can also obtain 215 supplemental data as needed, to the extent it is lacking from the gathered vehicle data. Machine learning may also be very useful in this regard, especially deep-learning, which can be capable of recognizing complex interrelationships between large data sets, and effectively drawing correct conclusions, without necessarily being able to explain the components. Since the outcome (the observed error or undesirable state) is known, vast reference sets resulting in this error can be fed into deep-learning, which should effectively be able to eventually simply predict when a given error or condition will occur for a given vehicle under given characteristics at a given location.

FIG. 2C shows illustrative examples of error observation, demonstrating a non-limiting set of observed undesirable states or vehicle events which may correlate to vehicle characteristics/traits, environmental characteristics or both. Here, the process obtains 221 road data (location, composition, etc.) and then determines if, for example, unexpected rapid lane change 223, off-road conditions 225, a multi-stop turn 227, unexpected reversal 229, an impact 231, a rapid acceleration change 233, excessive yaw/pitch/roll 235, antilock brake system (ABS) engagement 237, suspension/shock over-use 239 or wheel-slip 241 occurs. The error, whether it be one of the listed or another repeatable error, can be logged 243 as a trigger.

Since the condition is a repeatable one, other vehicles, or at least the same vehicle under the same conditions, should also experience the condition if it is an actual problem related to vehicle characteristics or environmental characteristics. Repeat occurrences of the trigger, along with the attendant data gathering, can eventually reveal the root-causes. This information can then inform a decision about at least either changing or prioritizing a road improvement or alerting drivers, or both.

For example, a one-foot pothole will likely cause unexpected suspension readings in virtually every vehicle crossing it. Impact and damage may result to some, but almost no vehicle should be able to cross a one-foot pothole without a registerable change. Because this is affecting 100 percent (or near to it) of drivers at the specific location, it is reasonable to conclude that this is a road condition. Further, it is reasonable to inform 100 percent of drivers whose route crosses that location of the condition, because it is not tied to a given vehicle. The city could prioritize the repair, but at least the drivers would not be unaware until the repair had been completed.

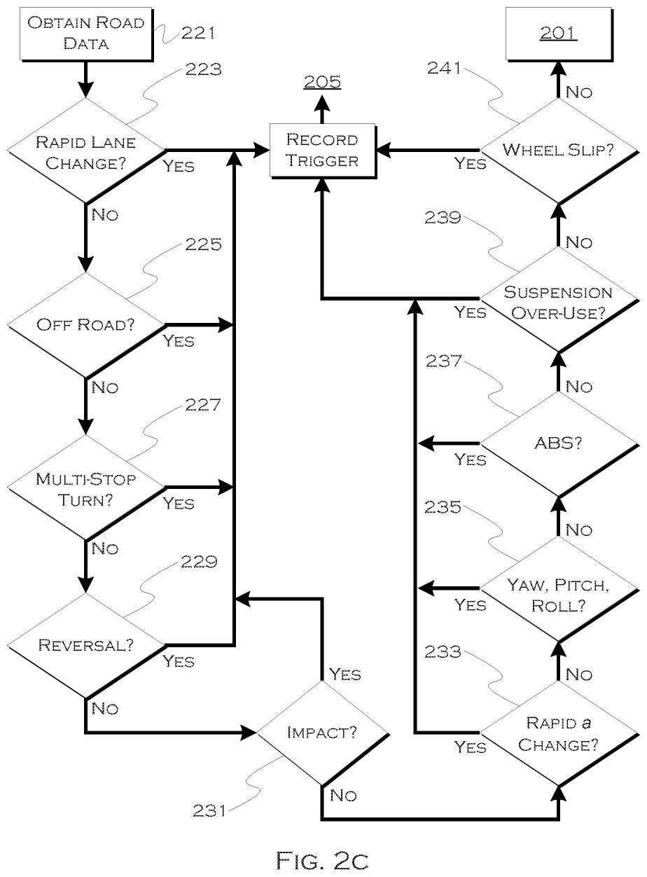

FIG. 3 shows an illustrative process for problem-targeting and monitoring. Once the analyzation process has received data, the process can compare 301 the received data to existing data sets to determine if sufficient data 303 exists to draw a reasonable conclusion. For example, if every vehicle of 1000 reporting vehicles experienced the same problem, this is probably sufficient diagnosis data in many instances. But if 4,000 of 20,000 vehicles, not sharing any particular characteristic, reported the problem, more information might be needed. In that case the process can add 305 the vehicle data 305 to a data set and then begin specifically attempting to diagnose the condition through monitoring 307.

Diagnosing a condition may be possible when a number of vehicles share certain characteristics when reporting a problem, but not enough characteristics to conclusively decide the cause of the problem.

It is worth noting that when the characteristic is tied to an environment, this can include both natural and man-made environmental conditions. For example, collisions or scrapes along concrete barriers may occur only or commonly in times of very high traffic at a given location. This would tend to indicate that in high traffic, the barriers may be too close to the road, and a certain portion may be difficult for drivers to avoid. Information such as this can be used to inform drivers, or drivers of certain types of vehicles, to avoid those areas in high traffic, and/or to inform a city about the value of moving the barriers away from the lanes of travel. This is a combination of factors, for example, where a vehicle width plus an environmental condition may be revealed as a cause, and where further the cause may be tied to an easily correctable feature (assuming the barrier is not permanently installed).

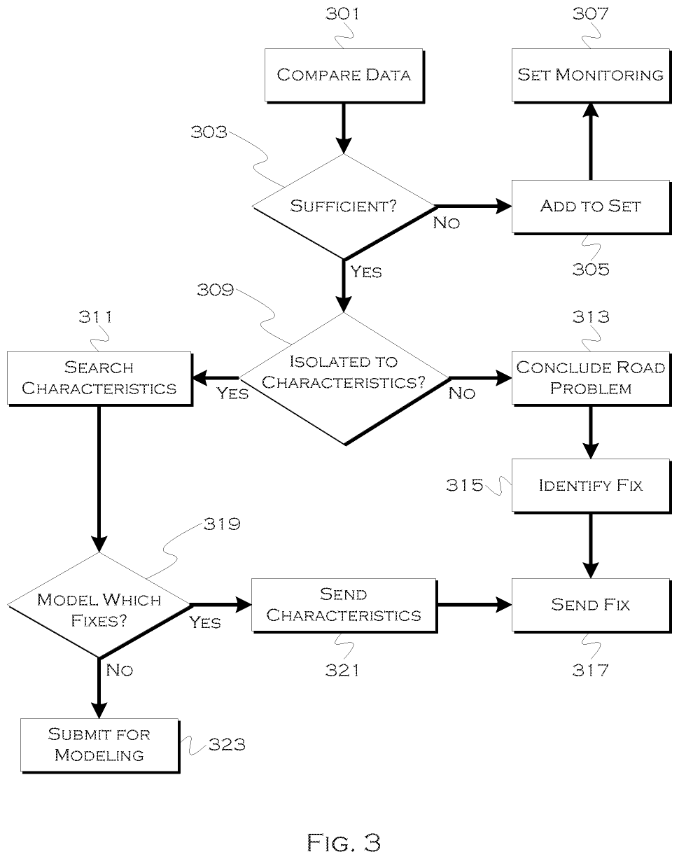

FIG. 4 shows an illustrative monitoring-distribution process that can be used in furtherance of diagnosing the problem. Since this solution ties a problem to a location, even if the root-cause is a vehicle characteristic, the process can set 401 a range (geographic) for monitoring. This will provide an area-of-interest for monitoring. With sufficiently detailed GPS coordinates, the range may be more limited, but with the current margins of error, the range may be large enough to ensure that results are not often-missed due to GPS reporting error.

Since the process is effectively hypothesizing at a problem's root causes, at this point, the process may set a variety of monitoring characteristics 403 of-interest. For example, if 40 percent of vehicles having the error were 10 feet long or longer, the process could tie one set of tracking to all 10 fo0ot vehicles passing through the area-of-interest. This is because vehicles not experiencing the problem may not always report, and thus the process may not know how many (as a percentage) of all 10 foot vehicles the reporting 10 foot vehicles represent. By having all 10 foot vehicles passing through the area report, the process can determine if this specific characteristic has a direct impact or not. Common characteristics can include both vehicle traits (generally fixed characteristics) or vehicle performance characteristics (e.g., without limitation, momentary variables such as speed, hard braking, etc.).

Similar queries can be made of all vehicles having a combination of characteristics as well, and by leveraging the data already possessed, the process can determine sets of candidate vehicles that are hypothesized to experience the condition. Similar sets can be built for environmental constraints, and the process can effectively produce a set of candidate vehicles and conditions that the process “guesses” will experience the problem. The process can then push 407 data gathering and reporting requests to vehicles filling one or more candidate roles, which are going to pass through the area-of-interest. This process can be performed iteratively, narrowing results until sufficient specificity or volume of results is achieved to accurately diagnose the problem.

One the process has met a diagnosis-threshold, sufficient under the reporting to conclude a reasonable culprit, the process then determines if the process is isolated to a set of vehicle characteristics. Again, this could leverage a process such as that in FIG. 4, to confirm results, or the data itself may already be sufficient to draw this conclusion.

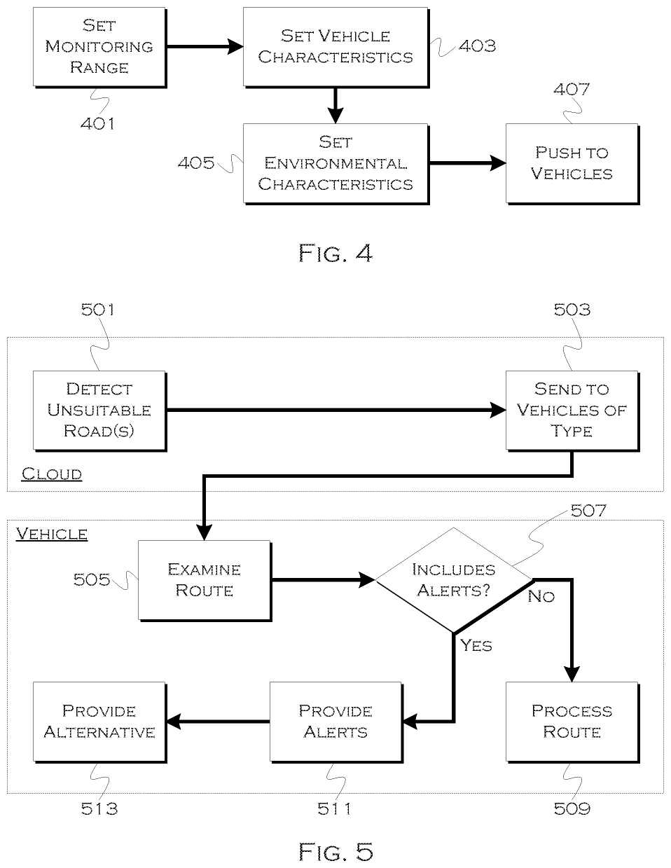

FIG. 5 shows an illustrative navigation alert and re-routing process. In this example, a central processing system can feed route data to a vehicle. The route-data can indicate potential problems along a planned route, which can be generic or specific to a vehicle and projected environmental conditions.

Here, the cloud finds 501 unsuitable locations within an area for vehicles having traits which correlate to undesirable events at those locations. The cloud could also receive planned routes and identify, per route, trouble areas. In the present model, the cloud can, for example, identify a location and correlated trait or environmental condition. If the identified event-causing aspect is a trait, the cloud can send 503 the data to vehicles having the known trait, within a predefined radius, for example, of the location. If the identified event-causing aspect is road-based or environmental, the processor can send the data to all vehicles with the radius (if road-based) or all vehicles within the radius during or when the environmental condition is likely to occur.

The vehicle receives the data and examines 505 a present route. Again, this could be done in the cloud or on a mobile device, but in this example the vehicle self-identifies likely problem areas along an upcoming route. If there are locations along the route that may cause an undesirable event, either because of a vehicle trait or an environmental condition (or both) 507, the process can provide 511 a driver alert and route around 513 the location. Otherwise, the vehicle can process the route. Since environmental conditions and location evaluations can change, the vehicle could receive data while a driver was en-route, and simply choose to examine the remainder of the route when the data arrives, so effectively the assistance can be provided to the driver as soon as the correlation or likelihood of encountering an undesirable event is known.

Vehicle traits can include, for example, without limitation, height, weight, length, clearance, class, model, etc. Current environmental conditions can include, for example, without limitation, weather, traffic, etc. Projected vehicle speeds and braking characteristics can be derived from both road-class behavior and observed driver behavior.

By correlating vehicle traits, environment and road traits to commonly observed undesirable events, the illustrative concepts and embodiments provide opportunities to improve the utility and functionality of both route-planning and city planning. Drivers can receive targeted event-avoidance advice pertinent to their specific vehicle and environment, and cities can improve certain roads or prioritize improvement based on both vehicle demographics and observed impact of road-events on the vehicle demographics. The novel, uncommon and atypical examples and concepts described herein demonstrate potential improvements achievable through use of those examples, concepts, and the like.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
receive data indicating a detected vehicle-event, event location, and vehicle traits;
add the data to a combined set of events occurring within a predefined proximity of the location;
responsive to occurrence of the events in the set exceeding a threshold, for the location, determine, from the set, a common vehicle trait; and
designate the location as likely to cause the event for vehicles having the trait.

2. The system of claim 1, wherein the trait includes vehicle length.

3. The system of claim 1, wherein the trait includes vehicle width.

4. The system of claim 1, wherein the trait includes vehicle height.

5. The system of claim 1, wherein the trait includes vehicle weight.

6. The system of claim 1, wherein the trait includes vehicle model.

7. The system of claim 1, wherein the trait includes vehicle class.

8. The system of claim 1, wherein the trait includes vehicle clearance.

9. The system of claim 1, wherein the trait includes a vehicle state characteristic.

10. The system of claim 9, wherein the characteristic includes speed.

11. The system of claim 9, wherein the characteristic includes degree of braking.

12. A system comprising:
a processor configured to:
receive data indicating a detected vehicle-event, event location, and environmental condition;
add the data to a combined set of events occurring within a predefined proximity of the location;
responsive to occurrence of the events in the set exceeding a threshold, for the location, determine, from the set, a common environmental condition; and
designate the location as likely to cause the event for vehicles when the condition is present.

13. The system of claim 12, wherein the condition includes rain.

14. The system of claim 12, wherein the condition includes ice.

15. The system of claim 12, wherein the condition includes snow.

16. The system of claim 12, wherein the condition includes traffic-level.

17. A system comprising:
a processor configured to:
determine that a route includes a location predesignated to cause a predefined undesirable vehicle event, based on a vehicle trait or environmental condition pre-associated with the location as an event cause;
responsive to a vehicle traveling the route having the trait, or condition likely to be present when the vehicle reaches the location, depending on a respective event cause type, recommend an alternative route avoiding the location.

18. The system of claim 17, wherein the trait includes a vehicle physical characteristic.

19. The system of claim 17, wherein the environmental condition includes a weather condition projected to be present at the location when the vehicle arrives at the location.

20. The system of claim 17, wherein the environmental condition includes a traffic condition projected to be present at the location when the vehicle arrives at the location.
